(19) United States
(12) Patent Application Publication
(10) Pub. No.: US 2026/0286093 A1
(43) Pub. Date: Sep. 24, 2026

(54) METHOD OF PRODUCING A RADIOPAQUE OBJECT, AND RADIOPAQUE STRUCTURE THEREFORE

(71) Applicant: UNIVERSITÉ LAVAL, Québec (CA)

(72) Inventors: Marc-André FORTIN, Québec (CA); Théophraste LESCOT, Québec (CA)

(21) Appl. No.: 19/514,224

(22) PCT Filed: Aug. 29, 2024
(86) PCT No.: PCT/CA2024/051120

§ 371 Date: Feb. 25, 2026

Related U.S. Application Data
(60) Provisional application No. 63/580,097, filed on Sep. 1, 2023.

(51) Int. Cl. C08K 3/08; B33Y 70/10; C08G 65/40

(52) U.S. Cl. CPC C08K 3/08; B33Y 70/10; C08G 65/40; C08K 2003/0887

(57) ABSTRACT

There is provided a method of producing a radiopaque object. The method generally having: mixing a plurality of metallic particles and a plurality of polymer particles into a liquid medium, said mixing including the plurality of metallic particles assembling around respective ones of the plurality of polymer particles and resulting in a plurality of first colloidal structures suspended in the liquid medium; incorporating a plurality of polymer pellets into the liquid medium, the polymer pellets having a first dimension greater than a second dimension of the polymer particles, said incorporating including the plurality of first colloidal structures assembling around respective ones of the plurality of polymer pellets and resulting in a plurality of second colloidal structures; separating the plurality of second colloidal structures from the liquid medium; and forming the plurality of second colloidal structures into the object.

### FIELD

The improvements generally relate to producing objects, and more particularly to producing objects that are radiopaque, i.e., opaque to ionizing radiation.

### BACKGROUND

Ionizing radiation refers to the concept of energetic particles that have the capacity to remove electrons from atoms and molecules present in environments or materials such as air, water, bodily tissue and the like. Examples of such ionizing radiation can include, but are not limited to, X-rays, alpha rays, beta rays, gamma rays and the like. It is known that ionizing radiation can travel unseen and pass through most materials made of low-Z materials (such as polymers, mainly made of carbon, oxygen and hydrogen). In some applications, such as in the medical industry, some treatments involve the use of ionizing radiation to treat some unhealthy tissue in the human body. However, overexposure of healthy tissue to ionizing radiation must be prevented. For instance, to prevent the unwanted ionizing radiation from reaching healthy body parts and organs during radiotherapy, high-z material parts such as thick lead or tungsten plates can be carefully positioned between the source of ionizing radiation and the healthy body parts and organs. Although existing ionization protection techniques have been developed until now to a satisfactory degree, more refined practices and technologies are still needed in many radiotherapy procedures (e.g., in external beam therapies, brachytherapy, and nuclear medicine) for blocking ionizing radiation to reach healthy tissues.

### SUMMARY

The body parts or organs to be protected using either radioprotective parts made of high-Z elements, radiopaque brachytherapy inserts, or other radiation screening devices are typically of varying sizes and shapes. Conventional screening devices based on general populational geometric approximations may not be optimal in all situations and for all patients treated. There is thus a need in producing objects which can, on the one hand, block ionizing radiation, and on the other hand, be sized, shaped and formed as to finely delineate the body parts or organs to be protected. Additive manufacturing (AM) equipment (e.g., fused filament fabrication (FFF) equipment) has been used to fabricate such personalised objects. However, most AM equipment use standard polymer feed material of a limited ionizing radiation blocking capacity, as exemplified in FIG. 1. Most polymers are radiolucent materials that express a poor capacity to block radiation (e.g., energetic photons, electrons, alpha particles, etc). Many personalized devices and tools in radiology, radiotherapy and in nuclear medicine, such as brachytherapy implants, shields, screens, and personalized radioprotection equipment, require a certain level of radiopacity in their components.

This disclosure alleviates at least some of the aforementioned drawbacks by disclosing a feed material which is useable with a typical FFF AM equipment, enabling the fabrication of personalised objects in sizes, shapes and forms), which are also satisfactorily opaque to ionizing radiation.

In accordance with a first aspect of the present disclosure, there is provided a method of producing a radiopaque object, the method comprising: mixing a plurality of metallic particles and a plurality of polymer particles into a liquid medium, said mixing including the plurality of metallic particles assembling around respective ones of the plurality of polymer particles and resulting in a plurality of first colloidal structures suspended in the liquid medium; incorporating a plurality of polymer pellets into the liquid medium, the polymer pellets having a first dimension greater than a second dimension of the polymer particles, said incorporating including the plurality of first colloidal structures assembling around respective ones of the plurality of polymer pellets and resulting in a plurality of second colloidal structures; separating the plurality of second colloidal structures from the liquid medium; and forming the plurality of second colloidal structures into the object.

Further in accordance with the first aspect of the present disclosure, the polymer particles can for example be made of a first extrudable polymer material, the polymer pellets made of a second extrudable polymer material, said forming can for example include extruding the plurality of second colloidal structures into a filamentary object.

Still further in accordance with the first aspect of the present disclosure, the first extrudable polymer material and the second extrudable polymer material can for example correspond to a same, given extrudable polymer material.

Still further in accordance with the first aspect of the present disclosure, the given extrudable polymer material can for example be selected from a group consisting of: polyether ether ketone (PEEK), nylon (polyamide), acrylonitrile butadiene styrene (ABS), polylactide (PLA), polycarbonate (PC), polyethylene terephthalate glycol (PETG), polycaprolactone (PCL), polypropylene (PP), polymethyl methacrylate (PMMA), polystyrene (PS), polyetherketoneketone (PEKK), polyethylenimine (PEI) and polyethylene (PE).

Still further in accordance with the first aspect of the present disclosure, the metallic particles can for example include a metallic material includes high-Z elements found in the solid form at room temperature and normal conditions.

Still further in accordance with the first aspect of the present disclosure, the first dimension of the polymer pellets can for example range between 100 microns to 20 mm.

Still further in accordance with the first aspect of the present disclosure, the second dimension of the polymer particles can for example range between about 100 nm to about 100 microns.

Still further in accordance with the first aspect of the present disclosure, the metallic particles can for example have a third dimension ranging between about 100 nm to about 100 microns.

Still further in accordance with the first aspect of the present disclosure, the metallic particles and the polymer particles can for example have at least one of: substantially similar dimensions, substantially similar volumes and substantially similar quantities.

Still further in accordance with the first aspect of the present disclosure, the second colloidal structures can for example have a metallic composition of at least 5%, preferably at least 10% and most preferably at least 20%.

Still further in accordance with the first aspect of the present disclosure, said separating can for example include drying a mixture having the liquid medium and the second colloidal structures from the liquid medium.

Still further in accordance with the first aspect of the present disclosure, the liquid medium can for example include an alcohol selected from a group consisting of: isopropanol, ethanol, and methanol.

Still further in accordance with the first aspect of the present disclosure, said mixing can for example include providing the plurality of metallic particles in the form of a first colloidal suspension, providing the plurality of polymer particles in the form of a second colloidal suspension, and mixing the first colloidal suspension and the second colloidal suspension to one another.

Still further in accordance with the first aspect of the present disclosure, said mixing the first colloidal suspension and the second colloidal suspension to one another can for example include gradually mixing the first colloidal suspension into the second colloidal suspension.

Still further in accordance with the first aspect of the present disclosure, the method can for example further comprise subjecting the liquid medium to at least one of an agitation step and a sonication step.

In accordance with a second aspect of the present disclosure, there is provided a radiopaque structure comprising: a polymer pellet having a first dimension between 100 microns to 20 mm, and a plurality of auxiliary colloidal structures assembled around the polymer pellet, the auxiliary colloidal structures having a polymer particle, the polymer particle having a second dimension ranging between about 100 nm to about 100 microns, and a plurality of metallic particles assembled around the polymer particle, the metallic particles having a third dimension ranging between about 100 nm to about 100 microns.

In accordance with a third aspect of the present disclosure, there is provided a method of producing a radiopaque feed material, the method comprising: mixing a plurality of metallic particles and a plurality of polymer particles into a liquid medium, said mixing including the plurality of metallic particles assembling around respective ones of the plurality of polymer particles and resulting in a plurality of first colloidal structures suspended in the liquid medium; incorporating a plurality of polymer pellets into the liquid medium, the polymer pellets having a first dimension greater than a second dimension of the polymer particles, said incorporating including the plurality of first colloidal structures assembling around respective ones of the plurality of polymer pellets and resulting in a plurality of second colloidal structures, the plurality of colloidal structures forming the radiopaque feed material.

Further in accordance with the third aspect of the present disclosure, the first dimension of the polymer pellets can for example range between 100 microns to 20 mm, the second dimension of the polymer particles ranging between about 100 nm to about 100 microns.

Still further in accordance with the third aspect of the present disclosure, the metallic particles can for example have a third dimension ranging between about 100 nm to about 100 microns.

In accordance with a fourth aspect of the present disclosure, there is provided a radiopaque feed material for use in additive manufacturing, the radiopaque feed material comprising: a matrix of extruded polymer having a plurality of metallic particles uniformly distributed within the matrix of polymer, the metallic particles having a dimension ranging between about 100 nm to about 100 microns, the radiopaque feed material having a metallic composition of at least 5 %, preferably at least 10 % and most preferably at least 20 %.

All technical implementation details and advantages described with respect to a particular aspect of the present invention are self-evidently mutatis mutandis applicable for all other aspects of the present invention.

In this disclosure, the term “radiopaque” characterizes a material which is opaque to ionizing radiation including, but not limited to, X-rays, alpha rays, beta rays, gamma rays, or other high-energy particles, in a manner which would offer a satisfactory protection against ionization by such radiation. In some applications, a radiopaque material should, for a defined thickness value, preferably block at least 95% or more of the incoming ionizing radiation.

Many further features and combinations thereof concerning the present improvements will appear to those skilled in the art following a reading of the instant disclosure.

### DESCRIPTION OF THE FIGURES

In the figures,

FIG. 1 is an oblique view of a sheet additively manufactured using a standard polymer feed material, in accordance with the prior art;

FIG. 2 is an oblique view of a sheet additively manufactured using a radiopaque feed material, in accordance with one or more embodiments;

FIG. 2A is an oblique and enlarged view of an exemplary main colloidal structure around which auxiliary colloidal structures are assembled, in accordance with one or more embodiments;

FIG. 3 is a flow chart of a method of producing a radiopaque object, in accordance with one or more embodiments;

FIG. 4A is a schematic view of a step of mixing metallic particles and polymer particles into a liquid medium, in accordance with one or more embodiments;

FIG. 4B is a schematic view of a step of the metallic particles assembling around respective polymer particles to form auxiliary colloidal structures, in accordance with one or more embodiments;

FIG. 4C is a schematic view of a step of incorporating polymer pellets into the liquid medium of FIG. 4B, in accordance with one or more embodiments;

FIG. 4D is a schematic view of a step of the auxiliary colloidal structures assembling around respective polymer pellets to form main colloidal structures, in accordance with one or more embodiments;

FIG. 4E is a schematic view of a step of removing the liquid medium from the main colloidal structures, in accordance with one or more embodiments;

FIG. 4F is a step of forming an object from the main colloidal structures of FIG. 4E, in accordance with one or more embodiments;

FIG. 5 is a schematic view of steps of an exemplary method of producing a radiopaque filament, in accordance with one or more embodiments;

FIG. 6A is an enlarged view of some exemplary PEEK polymer particles, in accordance with one or more embodiments;

FIG. 6B is a graph showing a size distribution of the PEEK polymer particles of FIG. 6A, in accordance with one or more embodiments;

FIG. 7A is an enlarged view of some exemplary tungsten metallic particles, in accordance with one or more embodiments;

FIG. 7B is a graph showing a size distribution of the tungsten metallic particles of FIG. 7A, in accordance with one or more embodiments;

FIGS. 7E and 7F show enlarged views of some exemplary silver metallic particles, in accordance with one or more embodiments;

FIG. 7A is an enlarged view of some exemplary main colloidal structures, showing auxiliary colloidal structures assembled around respective polymer pellets, in accordance with one or more embodiments;

FIG. 7B is an enlarged view of one of the main colloidal structures of FIG. 7A, with the dash line showing an interface between the metallic particles and polymer particles, in accordance with one or more embodiments;

FIG. 7C is a backscatter view of the main colloidal structures of FIG. 7B, in accordance with one or more embodiments;

FIG. 7D is a schematic view of the main colloidal structure of FIG. 7B, in accordance with one or more embodiments;

FIG. 7E is an enlarged view of an example of a main colloidal structure, showing auxiliary colloidal structures assembled around the polymer pellet, in accordance with one or more embodiments;

FIGS. 7F, 7G and 7H are enlarged views of the auxiliary colloidal structures of FIG. 7E, in accordance with one or more embodiments;

FIG. 8A is a graph showing a metallic concentration as a function of radiopaque filament distance, in accordance with one or more embodiments;

FIG. 8B is a side elevation view of an example spool around which the radiopaque filament of FIG. 8A is looped about, in accordance with one or more embodiments;

FIG. 8C is a graph showing signal intensity as a function of tungsten concentration, in accordance with one or more embodiments;

FIG. 8D is a top plan view of exemplary samples of the radiopaque filament of FIG. 8A, in accordance with one or more embodiments;

FIG. 8E is an X-ray fluorescence image of the samples of FIG. 8D, showing that the filament sections are radiopaque, in accordance with one or more embodiments;

FIGS. 9A-9F are images of the radiopaque filament sections of FIG. 8D, showing an homogeneous distribution of metallic particles, in accordance with one or more embodiments;

FIG. 10A is an oblique view of a radiopaque object additively manufactured using the radiopaque filament of FIG. 8B, in accordance with one or more embodiments;

FIG. 10B is a top plan view of three objects side-by-side, the first object is made of pure PEEK, whereas the second and third objects are made from low-concentration and high-concentration radiopaque filaments, respectively, in accordance with one or more embodiments; and

FIG. 10C is an X-ray radiography of the three objects of FIG. 10B, showing the second and third objects blocking X-ray, in accordance with one or more embodiments.

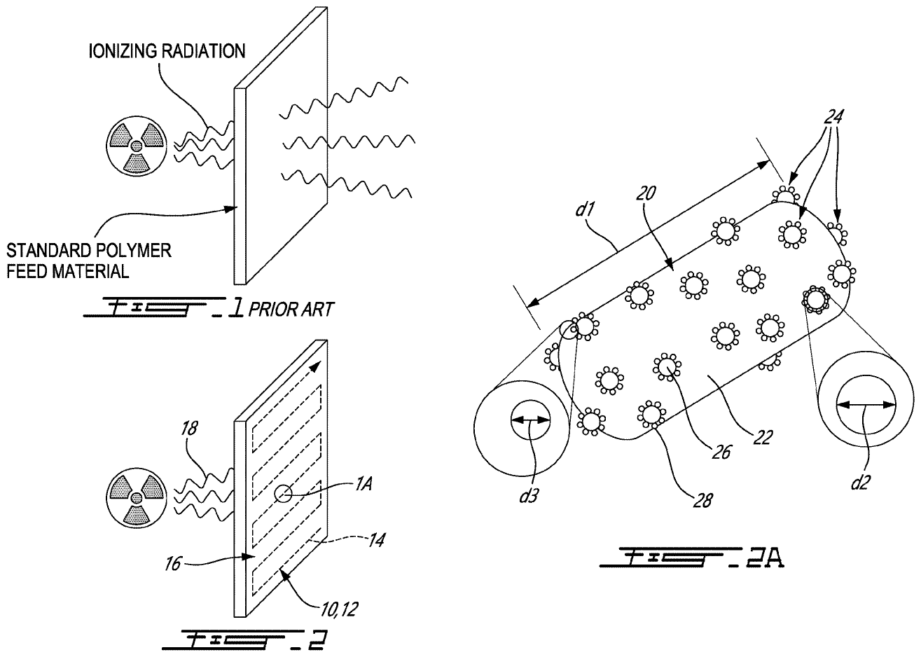

### DETAILED DESCRIPTION

FIG. 2 shows an example object 10 produced using an additive manufacturing (AM) technique based on the concept of fused filament fabrication (FFF). More specifically, the illustrated object 10 is provided in the form of a sheet 12 which has been produced by fusing a polymer filament and forming it into the sheet gradually. The FFF AM technique generally includes feeding polymer filament, generally provided in the form of a large spool, through a moving, heated printer extruder head (not shown) so as to deposit the fused polymer where desired to form the sheet. An example of a path 14 for the heated printer extruder head is shown in FIG. 2. The heated printer extruder head is generally moved under computer control to define the printed shape. Usually, the heated printer extruder head moves in two dimensions to deposit one horizontal plane, or layer, at a time. The object 10 or the heated printer extruder head is then moved vertically by a small amount to begin a new layer, and so forth, until the full object 10 is finished.

Still referring to FIG. 2, the sheet 12 is made of a feed material 16 which can be used in AM and which is opaque to ionizing radiation, hereinafter referred to as “radiopaque feed material 16,” i.e., a material opaque to ionizing radiation 18 such as X-rays. As schematically shown, the ionizing radiation 18 is blocked by the radiopaque sheet 12. The radiopaque feed material 16 used to produce the radiopaque sheet 12 using AM benefits from the uniform distribution of metallic particles into its extrudable polymer matrix. Producing such a radiopaque feed material 16 has been challenging, as the mere mixing of metallic particles into a polymer matrix would lead to the metallic particles clogging together which would in turn lead to an inconsistent distribution of the metallic particles in the extrudable polymer matrix. Although forming an object using such an inconsistently distributed extrudable polymer matrix in AM is in fact possible, the objects formed using such an inconsistent feed material may not be satisfactorily radiopaque as ionizing radiation can propagate through the polymer matrix, between regions of high metallic density (e.g., between the metallic clogs). In other words, the space between adjacent metallic clogs would be too large to block a satisfactory fraction of the incoming ionizing radiation. The method disclosed herein allows the production of a radiopaque feed material 16 having metallic particles uniformly distributed within an extrudable polymer matrix, and which stays relatively uniformly distributed during and after formation using the typical AM technique, so as to produce objects of satisfactory radiopacity, such as the radiopaque sheet 12 of FIG. 2.

FIG. 2A shows an example of a radiopaque structure 20 used to form such radiopaque feed material 16 with which is produced the radiopaque sheet 12 of FIG. 2. In fact, the radiopaque feed material 16 generally consists of several such radiopaque structures 20 mixed together to form a radiopaque paste. The radiopaque paste can then be extruded, or otherwise formed or shaped, to form a radiopaque filament which can be looped into a spool. When a number of such radiopaque structures 20 are mixed together to form a radiopaque paste, and/or fused to form a radiopaque filament, the metallic particles uniformly distribute within the polymer matrix, thereby providing satisfactory radiopaque properties to the objects formed using the radiopaque filament. The uniform distribution of the metallic particles within the polymer matrix stems from the construction of the radiopaque structures. As depicted, the radiopaque structure 20 has a polymer pellet 22 having a first dimension d1 between 100 microns to 20 mm, and auxiliary colloidal structures 24 assembled around the polymer pellet 22. As shown, each auxiliary colloidal structure 24 has a polymer particle 26, and metallic particles 28 assembled around the polymer particle 26. The polymer particle 26 typically has a second dimension d2 ranging between about 100 nm to about 100 microns whereas the metallic particles have a third dimension d3 ranging between about 100 nm to about 100 microns. In the present disclosure, the radiopaque structure 20 can also be referred to as a main colloidal structure.

FIG. 3 shows an example of a method 300 of producing a radiopaque object. The method 300 can be performed in small lots or in large industrial batches, depending on the embodiment. As can be understood, the method 300 aims at creating a relatively important number of the main colloidal structures of FIG. 2A, which can then be used to form the radiopaque paste or filament.

At step 302, metallic particles and polymer particles are mixed into a liquid medium. The step 302 of mixing includes a step in which the metallic particles assemble around respective ones of the polymer particles within the liquid medium. Such an assembly results in the formation of auxiliary colloidal structures (also referred to as first colloidal structures) suspended in the liquid medium. The assembly of the metallic particles around the polymer particles can include some form of adhesion in which the metallic particles adhere around an exterior surface of the polymer particles in a somewhat uniform distribution therearound. In other words, a given number of metallic particles agglomerate around each polymer particle.

At step 304, polymer pellets are incorporated into the liquid medium containing the auxiliary colloidal structures. The step 304 of incorporating includes a step in which the auxiliary colloidal structures assemble around respective ones of the polymer pellets. Such an incorporation results in the formation of main colloidal structures (also referred to as second colloidal structures) suspended in the liquid medium. The assembly of the auxiliary colloidal particles around the polymer pellets can include some form of adhesion in which the auxiliary colloidal particles can uniformly adhere around an exterior surface of the polymer pellets.

At step 306, the main colloidal structures are removed from the liquid medium. In some embodiments, the step 306 of removing includes a step of drying the liquid medium until the main colloidal structures collectively form a dry paste.

At step 308, the main colloidal structures are formed into any desired object. The formation of the object can be performed using any suitable AM technique, and most preferably fused filament fabrication (FFF) in which the dry paste is fused into a radiopaque filament. As discussed above, as the main colloidal structures typically have a metallic composition of at least 5%, preferably at least 10% and most preferably at least 20%, and as they are uniformly distributed within the polymer matrix, the dry paste offers satisfactory radiopacity to the objects that are formed with the dry paste. In some embodiments, the step 308 can be omitted as the dry paste containing the main colloidal structures can be used as is.

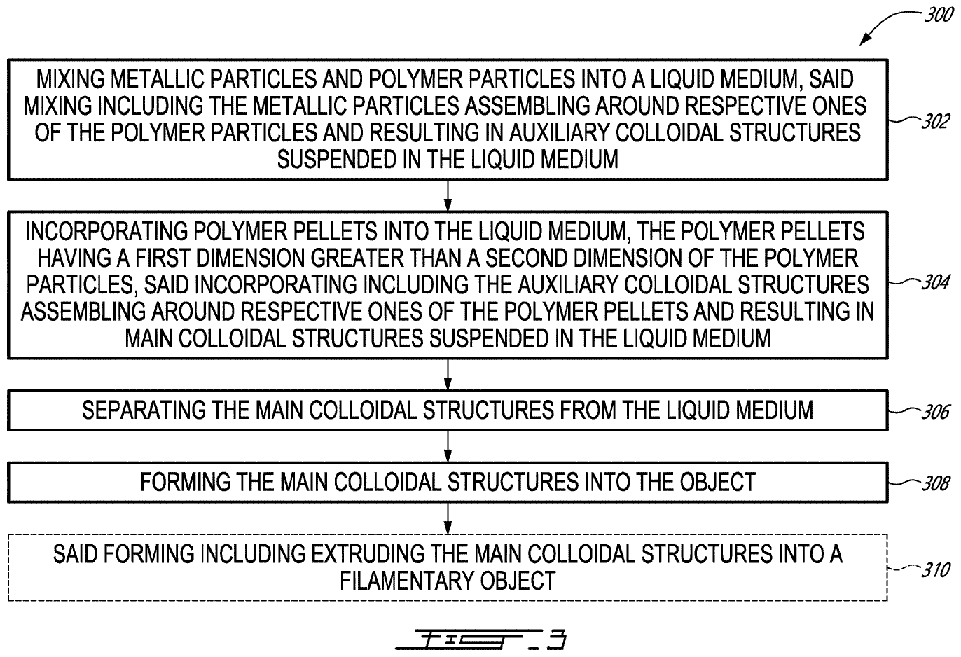

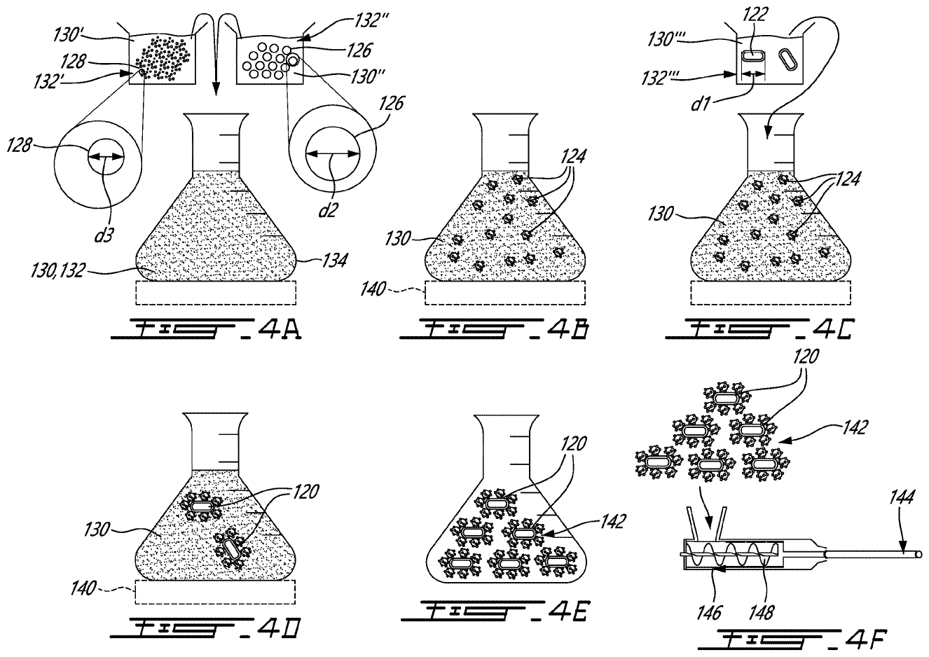

The method 300 presented above will now be described with reference to FIGS. 4A to 4F, which schematically illustrates some of the steps of the method 300. Referring now to FIG. 4A, metallic particles 128 and polymer particles 126 are mixed into a liquid medium 130. The liquid medium 130 can be any liquid in which the metallic particles 128 and the polymer particles 126 can be suspended or otherwise dispersed. Although any suitable liquid that neither dissolves or alter the polymer particles nor the metal particles, can be used as the liquid medium 130, a solvent such as isopropanol 132, ethanol, or methanol, and other alcohols was found to be particularly preferred. In some embodiments, the metallic particles 128 and the polymer particles 130 can both be suspended in a respective liquid medium 130′ and 130″, which can be the same liquid medium or different liquid mediums, thereby forming respective first and second colloidal suspensions 132′ and 132″, respectively. In the illustrated embodiment, the first colloidal suspension 132′ containing the metallic particles 128 and the second colloidal suspension 132″ containing the polymer particles 126 are poured, simultaneously or sequentially, into a container 134 containing some liquid medium 130 as well. The container 134 could have been empty in some circumstances. In some other embodiments, the first colloidal suspension 132′ containing the metallic particles 128 can be poured into the second colloidal suspension 132″ containing the polymer particles 126, or vice versa. The pouring of the first and/or second colloidal suspensions 132′ and 132″ can be performed in a single pour, or in a plurality of successive, small pours, depending on the embodiment.

As best shown in FIG. 4B, the metallic particles 128 assemble around respective ones of the polymer particles 126 and result in auxiliary colloidal structures 124 suspended in the liquid medium 130. In some embodiments, it can be preferable to provide agitation, or sonication, or a combination of both, using an exemplary agitator 140, to the liquid medium 130 to avoid the metallic particles 128 or the polymer particles 126 from undesirably clogging together prior the formation of the auxiliary colloidal structures 124 and even after their formation. Such agitation is especially useful in situations where the metallic particles 128 are supplied with some agglomerations prior to their pouring into the liquid medium 130.

In some embodiments, the container 134 is omitted. In these embodiments, it was found convenient to pour a fraction (e.g., a first fourth) of the first colloidal suspension 132′ into the second colloidal suspension 132″, all the while performing at least some agitation or sonication to favour the dispersion of the metallic particles 128 and their assembly around the polymer particles 126. Then, a subsequent fraction (e.g., the second fourth) of the first colloidal suspension 132′ can then be poured into the second colloidal suspension 132″, and so forth, until enough of the first colloidal suspension 132′ is poured into the second colloidal suspension 132″.

FIG. 4C shows the incorporation of polymer pellets 122 into the liquid medium 130 of FIG. 4B. In this embodiment, the polymer pellets 122 can be added directly to the liquid medium 130 containing the auxiliary colloidal structures 124. In some other embodiments, the polymer pellets 122 can be suspended into a similar or different liquid medium 130″, thereby forming a third colloidal suspension 132″. As such, the third colloidal suspension 132″ containing the polymer pellets 122 can be poured into the colloidal suspension containing the auxiliary colloidal structures 124. After the incorporation of the polymer pellets 122, the auxiliary colloidal structures 124 assemble around respective ones of the polymer pellets 122 and result in main colloidal structures 120 suspended in the liquid medium 130, such as shown in FIG. 4D.

It is noted that the polymer pellets 122 have a first dimension d1 greater than a second dimension d2 of the polymer particles. For instance, the first dimension d1 of the polymer pellets 122 can range between 100 microns to 20 mm, preferably between 200 microns to 10 mm, and most preferably between 0.5 mm to 5 mm. The second dimension d2 of the polymer particles 126 range between about 100 nm to about 100 microns, preferably between 200 nm to 50 microns, and most preferably between 500 nm to 25 microns. In some embodiments, the metallic particles 128 have a third dimension d3 which can range between about 100 nm to about 100 microns, preferably between 200 nm to 50 microns, an most preferably between 500 nm to 25 microns. The metal composition of the metallic particles 128 can vary from one embodiment to another. For instance, the metallic particles 128 can include a metallic material selected from a group frequently used on blocking radiation purpose and consisting of: tungsten (W), silver (Ag), gold (Au), platinum (Pt), tantalum (Ta), molybdenum (Mo), lead (Pb), barium (Ba), and more generally all materials made of high-Z elements found in the solid form at room temperature and normal conditions, usually found in the 5^{th} period of the periodic table and above (6^{th}, 7^{th}, including lanthanides and actinides).

Again, it can be preferable to provide agitation, or sonication, or a combination of both, to the liquid medium 130 to disperse the auxiliary colloidal structures or the polymer pellets and to prevent them from undesirably clogging together prior the formation of the main colloidal structures. In some embodiments, it was found convenient to pour a fraction (e.g., a first fourth) of the third colloidal suspension 132″ into the liquid medium 130 containing the auxiliary colloidal structures 124, all the while performing at least some agitation or sonication to favour the assembly of the auxiliary colloidal structures 124 around the polymer pellets 122. Then, a subsequent fraction (e.g., a second fourth) of the third colloidal suspension 132′″ can then be poured into it, and so forth, until a sufficient amount of the third colloidal suspension 132′″ is poured into the liquid medium 130 containing the auxiliary colloidal structures 124.

The liquid medium 130 can then be separated from the main auxiliary colloidal structures 120, as schematically illustrated in FIG. 4E. In some embodiments, the mixture including the liquid medium 130 and the main colloidal structures 120 is heated to evaporate a portion or an entirety of the liquid medium 130. In some other embodiments, the mixture is left exposed to the ambient environment for drying, which eventually wholly or partially removes the liquid medium 130 from the mixture, leaving the main colloidal structures 120 as a dry paste 142.

The dry paste 142 can be formed into an object via any suitable AM equipment. The object can have any size, shape or form, depending on the application. Any suitable AM equipment can be used. In some embodiments, the polymer particles 126 are made of a first extrudable polymer material and the polymer pellets 122 are made of a second extrudable polymer material. In these embodiments, the extrusion of the dry paste 142 comprising the main colloidal structures 120 is formed into a filamentary object or radiopaque filament 144. The radiopaque filament 144 can be formed into a spool in some embodiments. Depending on the embodiment, the first and second extrudable polymer materials can correspond to the same, given extrudable polymer material. An example of such an extrudable polymer material can include, but is not limited to, polyether ether ketone (PEEK), nylon (polyamide), acrylonitrile butadiene styrene (ABS), polylactide (PLA), polycarbonate (PC), polyethylene terephthalate glycol (PETG), polycaprolactone (PCL), polypropylene (PP), polymethyl methacrylate (PMMA), polystyrene (PS), polyetherketoneketone (PEKK), polyethylenimine (PEI) and polyethylene (PE) and the like. PEEK was found to be particularly useful in medical applications as it is often used for medical implants. However, any other suitable extrudable polymer can be used depending on the end application.

For extrusion to be successful, especially when using an extruder 146 having an endless screw 148, such as shown in FIG. 4F, an amount of void extending between the main colloidal structures 120 is necessary. In some embodiments, the volume of the paste formed from the main colloidal structures 120 has at least 48% of void, leaving the other 52% for the metallic and polymer materials. The metallic particles 128 and the polymer particles 126 have substantially similar dimensions, substantially similar volumes and/or substantially similar quantities. For instance, in an embodiment, the dry paste 142 has a metallic composition of about 16-20% by volume and a polymer composition of about 16-20% by volume. As such, the main colloidal structures 120, together with the void separating them, collectively act as a volume extrusion vector in which the endless screw 148 can turn without compacting the dry paste 142 in a way which would prevent its rotation. In some other applications, the content of the dry, radiopaque paste 142 can vary, as extruder can have pressing pistons and the like, which would not require as much void in the paste.

In some applications, the objects to be formed with the radiopaque filament 144 are in the order of the millimeter. Accordingly, metallic particles 128 should preferably be spaced apart from one another by no greater than 100 microns, preferably no greater than 75 microns, and most preferably no greater than 50 microns, within the radiopaque filament 144 for it to exhibit satisfactory radiopaque properties.

### Example—3D Printing of Radioopaque Therapeutic Objects by Fused Filament Fabrication (FFF)

Polymeric biomedical objects produced by additive manufacturing (AM) (i.e. “3D printing”) have now entered several fields of medicine. AM works by building a model from the ground up, depositing the materials in a layer-by-layer manner using digitally controlled and operated material laying tools. One of the most widely available AM technique is Fused Filament Fabrication (FFF) which can be used to print polyether ether ketone (PEEK), nylon (polyamide), acrylonitrile butadiene styrene (ABS), polylactide (PLA), polycarbonate (PC), polyethylene terephthalate glycol (PETG), polycaprolactone (PCL), polypropylene (PP), polymethyl methacrylate (PMMA), polystyrene (PS), polyetherketoneketone (PEKK), polyethylenimine (PEI) and polyethylene (PE) and the like. AM is a highly flexible processing technique that has expanded from rapid production prototypic methods, to an important tool in the field of personalized medicine: fabrication of patient-specific surgical models, bone implants, dental moulds and implants, and scaffolds for tissue engineering. The fabrication of inexpensive and personalized radiotherapy tools utilized by clinicians in radiation therapy is also made possible through AM processes: beam modifiers to accommodate irregular patient surfaces, wedge filters to modify the isodose distribution, electron beam cut-outs for beam shaping, anthropomorphic radiotherapy phantoms to validate the overall deliverability of treatment plans involving imaging and dosimetry, etc. However, the two main challenges faced by AM in the development of personalized polymer objects, figure design accuracy (i.e. the 3D-printed parts lacks precision and conformity with respect to the initial computer-assisted design (CAD) prints), as well as the respect of physical and mechanical properties of the functional object designed according to the patient's anatomy.

Polyetheretherketone (PEEK) is a semicrystalline, polycyclic, aromatic thermoplastic belonging to the family of linear aromatic polymers. It was introduced in the late 1990s for the replacement of metal implants in orthopaedics applications and, since then, it has been used in a variety of applications due to its excellent properties of chemical resistance, high-temperature performance, high yield strength, lightweight, durability, stiffness, and fatigue resistance. PEEK is increasingly being used as a high-performance material for the fabrication of patient-specific long-term implant in surgery and in radiology. It is already used for permanent implants in cranio-maxillo-facial, spinal, and perodontic surgeries. In addition to this, PEEK is radiolucent and MRI-compatible. Because of its resistance to radiolysis—i.e., radiation-induced degradation—PEEK can be considered for radioactive waste storage, as well as for the fabrication of radioactive implants. PEEK was recently introduced as an encapsulation material for brachytherapy seed spacers (with metal ions for “positive” MRI contrast). PEEK can also retain metal nanoparticles in objects immersed in aqueous fluids. Thus the development of PEEK objects by 3D-printing is an opportunity to develop more precise, more refined brachytherapy procedures. The chemical inertness of PEEK and more particularly its resistance to sterilization and to biological fluids, its high mechanical strength, and now the possibility to reach sub-millimetric dimensions with a high degree of geometrical conformity in 3D printing, figure among the main advantages of this polymer for the development of novel radiological, radiotherapeutic, and radiation shielding technologies.

Although PEEK has been commercialized in the '80s, and proposed for biomedical applications in 1998, only recently have 3D printers been adapted to the semi-crystalline nature and high melting temperature of PEEK (340° C.). This limitation has been overcome by the introduction of new 3D printers with high-performance melting nozzles for FFF, operating at temperatures close to 500° C.

The number of reported technologies involving polymer filaments for 3D printing integrating at least one functional type of nanoparticles, has steadily increased in the past few years. The integration of carbon nanotubes, or metal nanoparticles into high-strength polymers such as PEEK, nylon, or others, is currently used as a very efficient way to improve the mechanical properties of 3D-printed polymers. Metal-nanoparticle-containing polymer filaments, such as based on polyvinylidene chloride (PVDC), have been commercialized and allow the printing of conductive parts such as capacitors, inductors, and RF filters.

The development of metal microparticle-containing PEEK filaments using the extrusion technique necessitates an optimal process for effectively mixing PEEK microparticles, metal microparticles, and PEEK macroparticles. This mixing process aims to ensure the homogeneous attachment of metal microparticles to the surface of PEEK microparticles before extrusion. Additionally, PEEK macroparticles serve as a volume carrier for the extrusion process.

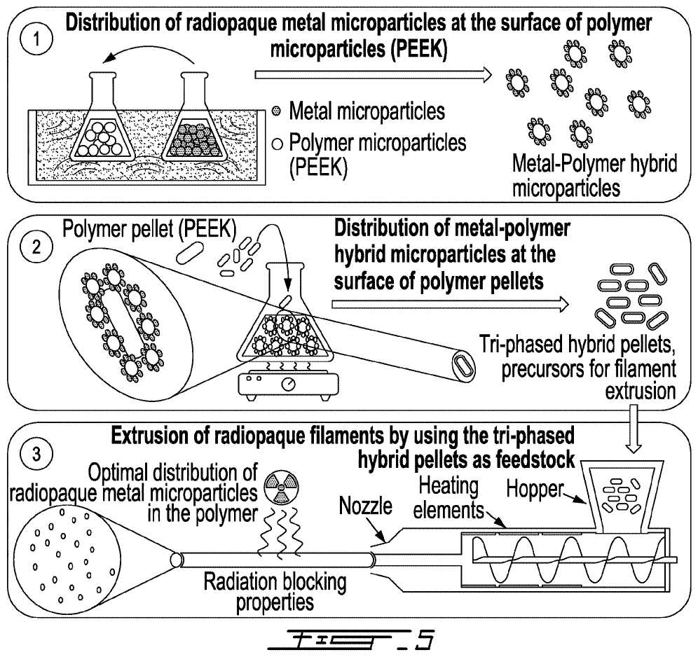

FIG. 5 provides a schematic representation of the process that was developed which, ultimately, leads to the production of polymer filaments for 3D printing that bear uniform distributions of micron-sized metal particles into polymer filaments. The process can also be applied to the production of filaments that contain nano-sized particles, provided stable colloidal solutions are used from the beginning as one of the major conditions for the success of the procedure.

As a first step, two (2) liquid solutions, one containing a stable dispersion of micron-sized PEEK particles (μPEEK), and the other one of micron-sized metal particles (in this example: μWand μAg), are mixed in specific volume ratios and according to a precisely tuned methodology using a combination of agitation and sonication. The volume concentration of the colloidal particles in each solution, and the respective relative volume fraction of one with respect to the other, are precisely calculated in a way as to avoid any metal particle in excess at the surface of the μPEEK particles. Step 1 leads to the production of metal-polymer hybrid microparticles, which are subsequently presented to millimetric-sized polymer pellets (here: PEEK pellets). This mixture is then referred to as “the tri-phased hybrid pellets” and constitute the feedstock for extruded polymer-metal filaments (step 3). Step 1 and step 2 are critical in the achievement of particle mixtures presenting very high-volume fractions of finely, uniformly, and well-separated distributions of metal particles inside the polymer matrix, ultimately leading the production of filaments that can be used in the production, by 3D printing, of millimetric-sized devices that have the capacity to block energetic X-rays. As the success of step 1 is largely conditioned by the production of stable and well-dispersed micron-sized colloids (such as μPEEK, and μW or μAg), a comprehensive demonstration of the quality of particle dispersion (step 1), particle adhesion at the PEEK pellets (step 2), thus leading to homogeneous particle dispersion in the filaments (step 3).

Ethanol, isopropanol, hexane, and toluene are solvents that are not expected to induce the degradation of either PEEK, or W, or Ag particles. The dispersibility and colloidal stability of the three (3) types of micron-sized particles, were assessed in these solvents according to a methodology based on a laser beam transmission technique. None of the particles formed a stable colloid in toluene and hexane. However, all particles were dispersible in isopropanol and ethanol, with indications of longer colloidal stability times in isopropanol, and this for the three types of particles. Longer colloidal stabilities were evidenced for the μPEEK particles, which can be in a large part attributed to the low density of the polymer, compared with the density of the two metal particles. The two (2) metal particle systems were relatively stable for a period of a few minutes, although signs of sedimentation appeared relatively quickly at the bottom of the cuvette, which was expected given the size and the density of the two (2) metals. Further colloidal stability tests were performed using the laser pointer bench test, this time by using a colloidal mix of μPEEK and μW particles. The spot intensity of the laser revealed a window of stability within the first 15 minutes, followed by an increase in the intensity of transmitted photons (indication of colloidal concentration decrease). These results indicated that the presence of the polymer microparticles in isopropanol does have a stabilizing effect on the colloidal dispersion of the micron-sized metal particles, therefore allowing a relatively long period of time for the preparation of homogeneously mixed and distributed particle preparations. Finally, the hydrodynamic diameters of the three colloidal solutions in isopropanol (μPEEK, μW, μAg), were assessed by laser diffraction analysis, which confirmed mean hydrodynamic diameter sizes of 10.1-10.2 mm, 8.03-9.05 mm, and 25.7-38.9 mm, respectively. The latter result indicated that the Ag particles used for the present example which, according to the fabricant were produced with a technology allowing the generation of separate particles, could be constituted of agglomerates that would be hard to disperse. The results related to the use of μAg and generated through this example were conserved in this paper to demonstrate the importance of preparing colloidal solution of the highest quality, with non-agglomerated particles from the beginning of the process.

Overall, these results confirmed that i) isopropanol is a solvent that can be effectively used in the preparation of colloidal suspensions of both PEEK and metal particles (W, Ag), ii) the necessity to proceed to steps 1 and 2 of the mixture preparation (FIG. 5) by using agitation and sonication, in order to enable a constant agitation of the colloidal system throughout the process; iii) the stabilizing impact of the micro-sized polymer particles on the micron-sized metal particles in the colloidal suspensions that constitute one of the precursors of the “tri-phased” hybrid particle system (end of step 2).

Samples of micron-sized PEEK particles (μPEEK), W (μW), and Ag (μAg) dispersed in isopropanol, were dried and visualized in SEM (FIG. 6). Whereas the laser diffraction measurements indicated that both μPEEK and the μW particles seemed to be made of relatively well-dispersed particles, SEM analyses provide further proofs that neither μPEEK nor μW were made of aggregates (FIG. 6). The μPEEK particles showed an average size distribution of 8.70±3.63 mm, whereas that of μW was of 1.28±0.59 mm. These results confirm the necessity to proceed to a systematic particle size analysis when particles from commercial sources are used for the preparation of polymer filaments, since in this case and according to the materials provider, approximate particles sizes of ~10 μm and 1-5 μm were expected, respectively. However, the most striking difference was evidenced for the μAg particles which, instead of the expected size range of 1-3 μm, revealed the presence of coarse aggregates (>30 mm; FIGS. 2E-F), which were also suggested by the laser diffraction analysis results. In fact, the aggregation behaviour of the μAg particles ultimately led to an incapacity to prepare relatively homogeneous and well-dispersed micron-sized particles, which, at a later step in the process, impeded the extrusion of continuous polymer filaments.

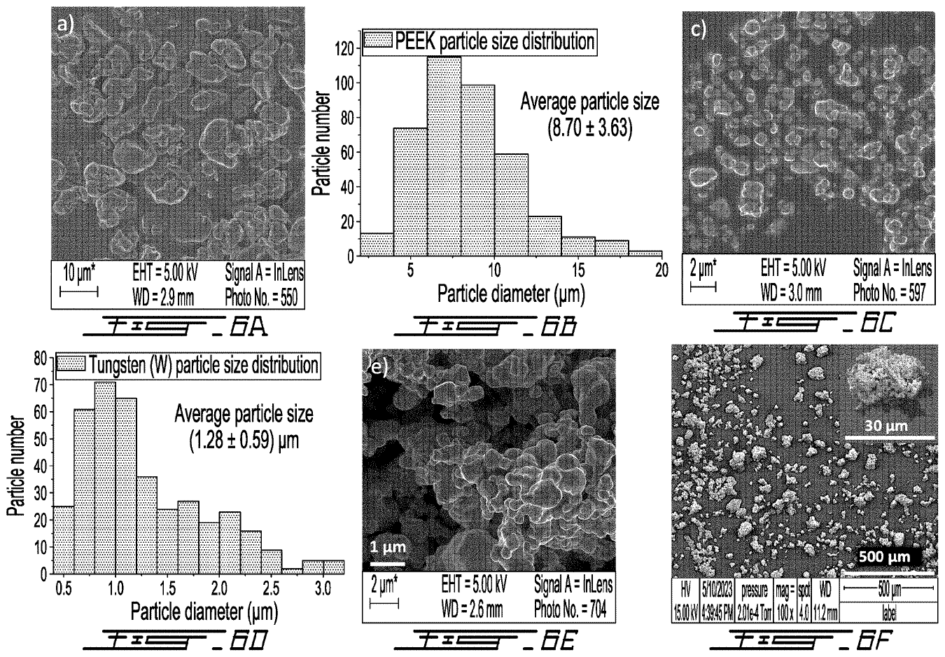

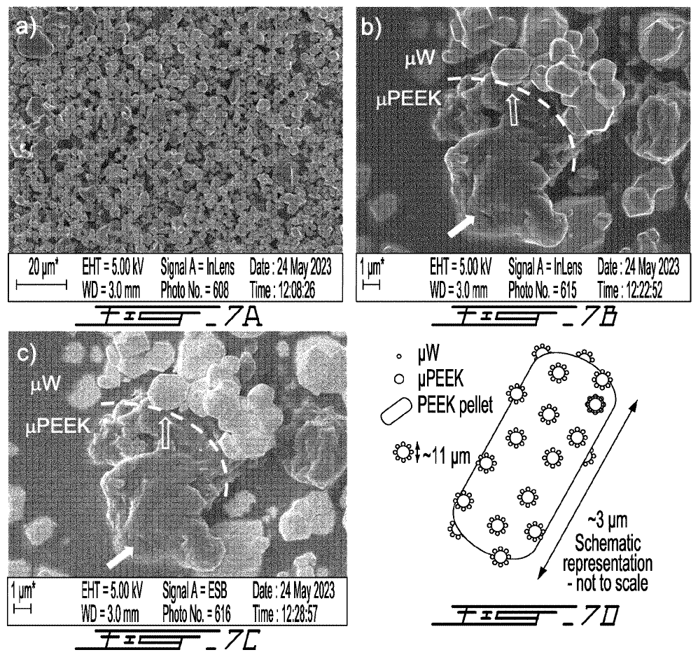

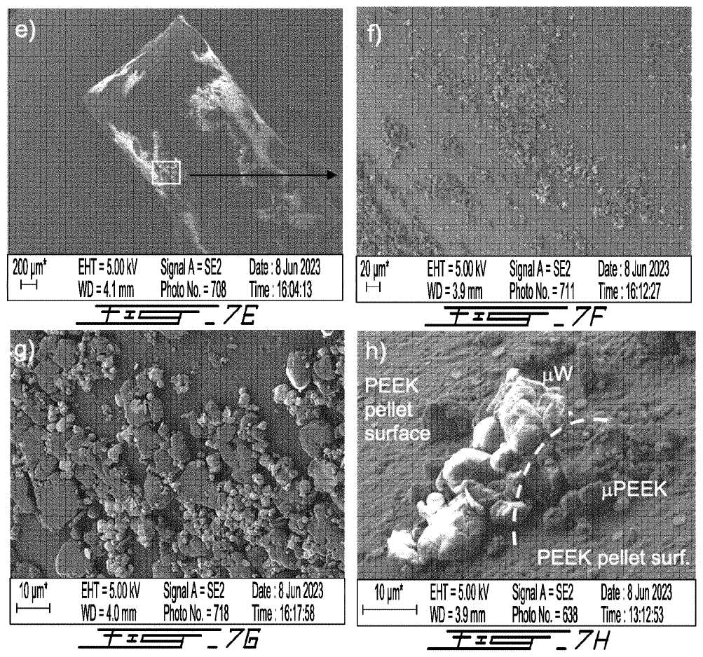

Micron-sized PEEK and W particles (μPEEK+μW) were mixed in isopropanol. The adhesion of μW particles onto μPEEK particles was confirmed by SEM (FIGS. 3A-B). This procedure of mixing μPEEK and μW particles was followed by the addition of commercial millimetric-sized PEEK pellets typically used for the extrusion of PEEK filaments for FFF. This last step ended by the elimination of isopropanol by drying and finalized the preparation of the polymer filament extrusion feed, referred to as the “tri-phased hybrid pellets” (represented in steps 2 and 3 of FIG. 5). The volume fraction of each component was precisely balanced. The quality of the μW particles adherence onto the μPEEK particles were confirmed by SEM (FIG. 7E-H), in both secondary electron (topographic information) and in backscattered electron (materials electron density information, i.e., contrast between polymer and metal areas) modes. Then, the thinness of the particle-metal hybrid microparticle preparation adherent on the PEEK pellets, was also assessed by SEM (FIG. 7D). Large areas rich in μW particles were evidenced on all PEEK pellets investigated. As expected from the general electrostatic properties of both types of particles (metal and PEEK), a relatively uniform coating was expected, without agglomerations. Fragments of the “satellite” configurations depicted in FIG. 5 and FIG. 7G), line the surface of the PEEK pellets. This configuration avoids the presence of mid-to-large-sized microparticles agglomerates which could have a disruptive impact on the filament extrusion process. Discontinuities in the microparticle film at the surface of the PEEK pellets indicate the possibility to further increase the volume fraction of the microparticles with respect to the PEEK pellets, in such a way that the complete surface of the pellets would be covered. For this reason, another series of “tri-phased hybrid pellets” were prepared with a higher concentration of microparticles (referred to as “Prototype 2,” or “high-concentration” preparation). Overall, these results confirmed the possibility to generate relatively thin and uniform layers of unaggregated metal-polymer hybrid microparticles (μPEEK+μW) at the surface of millimetric-sized PEEK pellets commonly used as a feed for filament extrusion of PEEK materials for FFF additive manufacturing. The systematic collection of SEM images obtained in the secondary electron mode and those obtained with the backscattered electron mode allow for very efficient comparative positioning between the metal particles (μW) and the polymer particles (μPEEK and PEEK pellets).

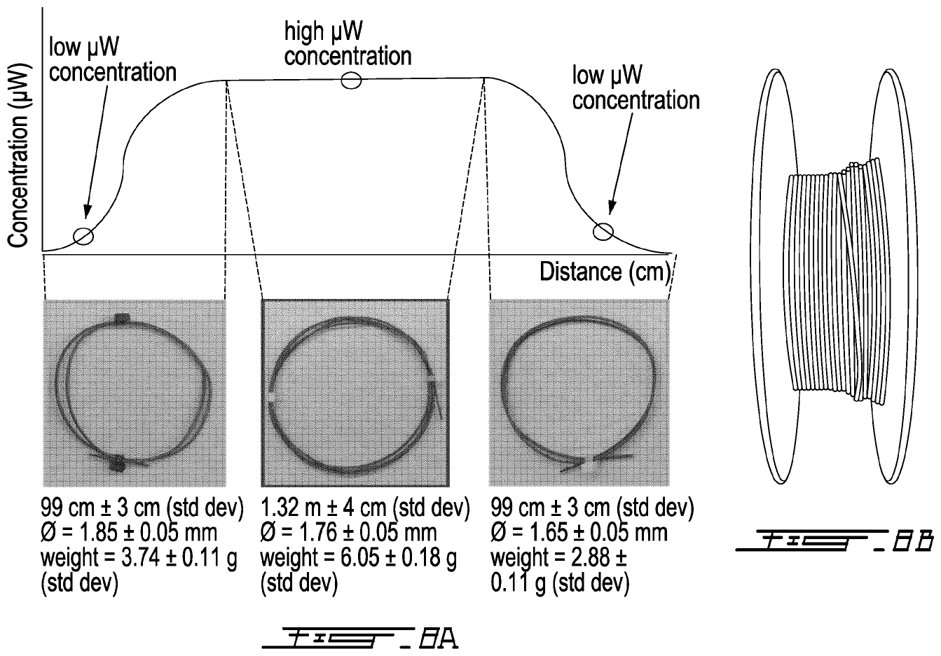

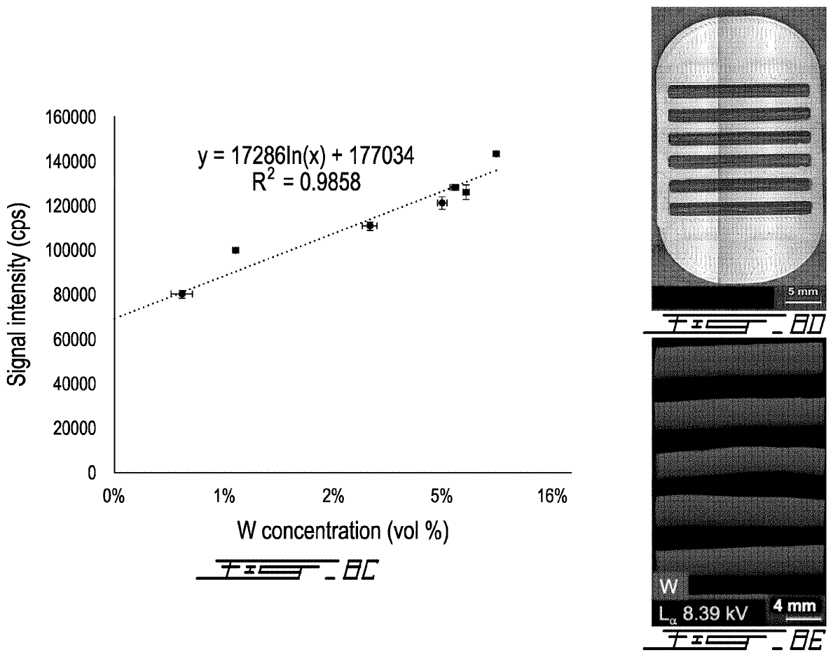

The “tri-phased hybrid pellets” were used to produce filaments containing two different loads of metallic particles. The two types of preparation are described as “low-density,” and “high-density” preparations. Polymer filament extruders in general feature a series of separate heaters—often referred to as “blocks”—which can be heated at different temperature levels (typically 395-405° C. for PEEK) in order to optimize either material blending by the vice, or the viscosity of the filament exiting the nozzle. In the present example, the temperature of each block was previously optimized by using pure PEEK. For the fabrication of each separate filament, the extrusion process was initiated by obtaining a continuous flow of PEEK, with the filament diameter set at a nominal value of 1.75±0.1 mm (measured by a laser device fixed closed to the nozzle). Whereas the extrusion process was smooth and very uniform for the two triplicate preparations of μW particles, the extrusion of Ag particles had to be discontinued due to the several mechanical disruptions of the filament. This effect was associated with the severe evidences of agglomeration noted in the μAg powder observed by SEM analysis (FIGS. 6E-F). It was concluded that, without changing the μAg powder for a highly dispersible form, the extrusion of a continuous, high-quality Ag-containing filament, would not be possible. From that point the present example was entirely focused on the characterization of μW-containing filaments (low and high concentrations). Illustrations of the extruded μW-containing filaments are shown in FIG. 8.

For each extruded filament, one first part was harvested from the point a typical coloration attributed to W appeared at the nozzle. The plateau represents the second part of the filament, and it revealed a relatively stable W concentration (FIG. 8A). Finally, a third part was extruded, of relatively lower W concentration, which corresponded to the decreasing gradient. Samples (2 cm-long) were collected along various gradient parts; these were digested in acidic solutions and analyzed by MP-AES in order to plot a correlation curve between W concentration and X-ray fluorescence signal (Lₐ W; FIG. 8C). Each filament corresponding to the central section of the extrusion process (the “plateau” part), was spooled in preparation of the 3D printing assessment experiments (FIG. 8C). Finally, 2-cm sections from sacrificial “plateau” parts were cut at intervals and analyzed with a mXRF system that allowed to reveal the homogeneity in the Lₐ W signal along each filament (FIGS. 8D-E), as well as the intensity of the signal which was correlated to a specific W concentration level (FIG. 8C).

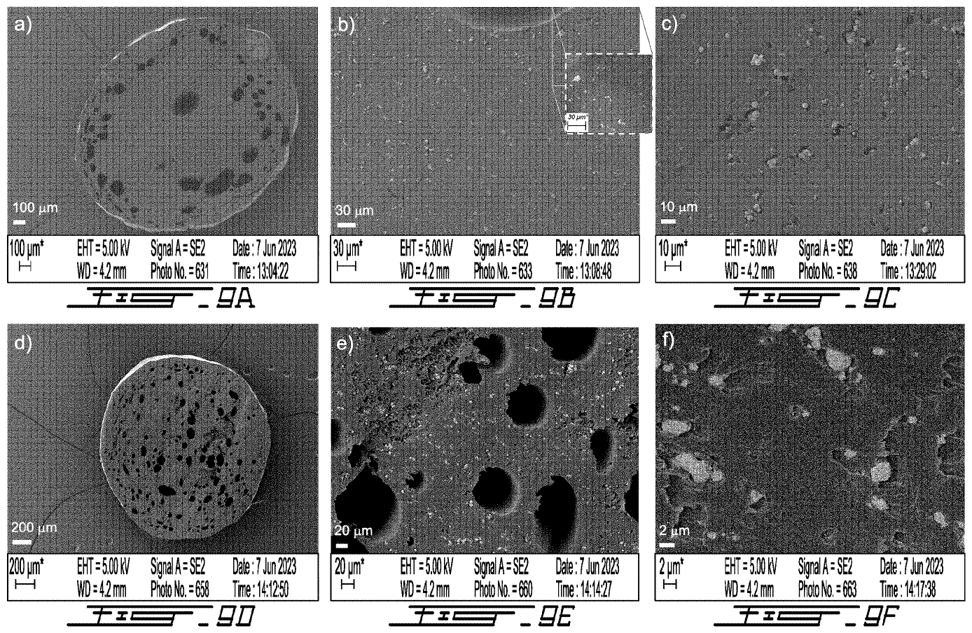

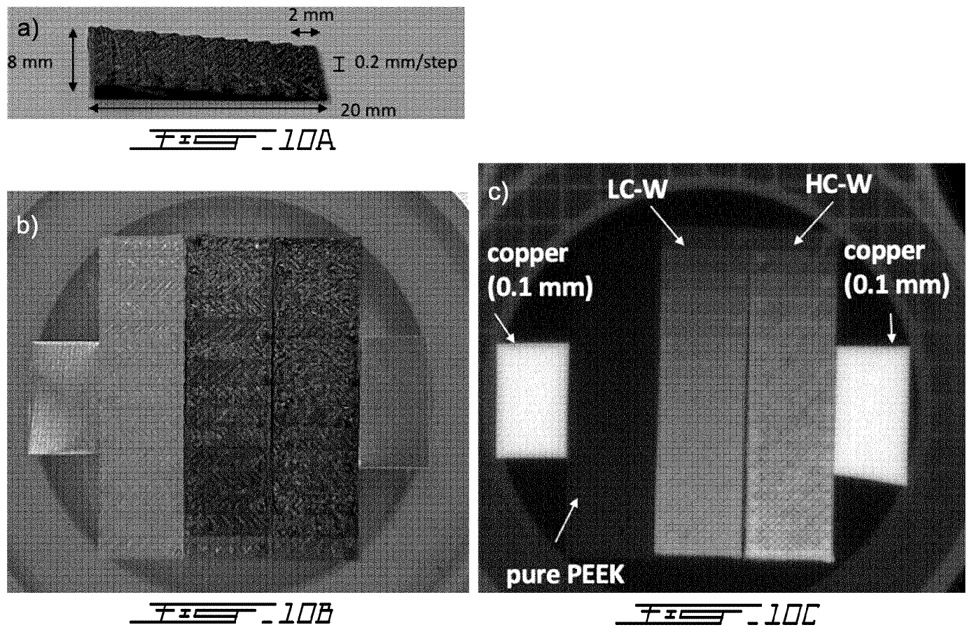

The homogeneity of metal microparticle distribution was assessed by SEM on three (3) sections harvested from three different parts of each “plateau” section. FIG. 9 depicts representative results from filaments obtained from the “low-concentration” (prototype 1) preparation (FIG. 9A-C), and from the “high-concentration” (prototype 2) preparation (FIG. 9D-F). In both filament types, the metal microparticles appeared very homogeneously dispersed, and no strong evidence of agglomerations was found. Both secondary electron and backscattered electron detectors were used for the microscopy analysis. In both modes the high-Z tungsten microparticles appear clearly contrasted with respect to the PEEK background. One striking feature of these filaments is the large number of porosities, which appeared dispersed throughout the section of the filaments. The mechanism by which these porosities appear during the extrusion process is not clearly identified at this step, and this question would require further investigation. One first explanation could be the residual presence of air captured between the PEEK, μPEEK, and μW particles, possibly not entirely eliminated during the melting and extrusion process due to the high viscosity of the PEEK material. Setting one of the extruder heating blocks at a higher temperature, still below the temperature at which PEEK could degrade, would decrease the viscosity thus enhance the coalescence and elimination of these porosities at the surface of the extruded filament. The second explanation is the possibility of a relatively high residual presence of water adsorbed at the surface of the μPEEK, and μW particles. The hygroscopic nature of PEEK is well known, and the extrusion of PEEK filaments, including by 3D FFF printers, requires a complete dehydration process prior to either extrusion or 3D printing.

After slight adjustments with respect to the extrusion temperature, rotating speed, and overall duration of the extrusion process, as well as after adding an extended 8 h-drying period for each of tin intrants (pure PEEK, PEEK-W pellets, and tri-phased hybrid pellets), the residual moisture seen in FIGS. 9D and 9E was carefully eliminated and the filaments were largely exempt from porosities. These adjustments also allowed to enhance the quality of 3D prints.

Isopropyl alcohol (purity 99%) was purchased from Fisher Scientific. Ethanol (purity 70%) and hexane (purity 95%) were purchased from Sigma-Aldrich. Tungsten (W) microparticles (μW, 1-5 μm diameter company estimate, purity 99.9%, metals basis, cat: 010400.22) and silver (Ag) microparticles (μAg, 1-3 μm diameter company estimate, purity 99.9%, metals basis, cat: 011405.18) were acquired from Alfa Aesar. Medical grade polyetheretherketone (PEEK) microparticles (μPEEK, ~10 μm diameter, company estimate) were acquired from Goodfellow Cambridge Ltd, UK. PEEK pellets of an average particle size ~3 mm was acquired from Innovatefil, Spain. Devoclean pellets of two (2) types, namely HighTemp (Tm: 180-310° C.) and MidTemp (Tm: 310-420° C.), were obtained from 3Devo (The Netherlands). The MidTemp cleaning product is made of high-density polyethylene (HDPE), whereas the HighTemp cleaning product is made of polyethersulfone (PES) with polytetrafluoroethylene (PTFE) as an additive.

The dispersibility of metal microparticles and PEEK microparticles, as well as their colloidal stability over time, were measured in different solvents (ethanol, isopropanol, and hexane). The solvent presenting the highest dispersibility and particle colloidal stability over time, was selected for the next steps (isopropanol). The hydrodynamic size of the colloids dispersed in isopropanol, was measured with a Mastersizer 3000 particle size analyzer (Malvern Panalytical). In each sample, a mass of 0.2 g of each type of particles was dispersed in isopropanol, and prepared as described above. Each sample was measured according to three (3) preparation parameters: i) moderate agitation speed (2500 rpm); ii) high agitation speed (3000 rpm); iii) sonication for 60 seconds, followed by 2500 rpm agitation. A 400 mL beaker containing 325 mL of dispersing media (isopropanol 70%), was used for running the Hydro SV small volume wet sample dispersion unit. The solutions having presented size distributions well under 100 microns, and ideally close to the mean diameter provided by the documents from the provider, were selected for the preparation of the triphased micro/millimetric particle mixture illustrated in FIG. 5.

The preliminary calculations leading to the volume ratios between μPEEK, μW, and μAg, and PEEK millimetric-sized pellets employed in the preparation of the triphased hybrid particles. In step A) metal microparticles (W, Ag) as well as PEEK microparticles, were dispersed in isopropanol under several cycles of agitation and sonication. For the preparation of W-based mixtures, two solutions were prepared, one containing 5.8 g/L (1.45 g/250 mL) μPEEK particles, and the other 40.4 g/L (10.1 g/250 mL) μW particles. Each one was prepared in a separate flat bottom round flask.

Two preparations for triphased compounds are referred to as 1) the “void space” method (or “prototype 1”, low-concentration) and 2) the “microparticles in excess” method (or “prototype 2”, high-concentration). For the “prototype 1” method (low-concentration), as Step B), the two-particle solutions were applied a two (2)-minute vigorous vortex step, followed by a 10-minute sonication step. This procedure was repeated 5 times, for up to one hour (60 min). Each particle solution was then considered fully dispersed and ready for the preparation of the metal-polymer hybrid microparticle preparation step (FIG. 5, step 1). Step C) The μPEEK particles solution in isopropanol (250 mL still in its flat-bottom preparation flask) was put in vigorous vortex and using a serological pipette, 4×25 mL of the μW particles solution was added. At least 20 seconds of vigorous agitation was maintained between each volume of 25 mL added, and after 100 mL, a 10-minute sonication step of the main flask followed. For this, the flask was tilted at 45° by the arm of a rotary evaporator, and left rotating for 10 minutes. At the end of each sonication step, a 2-min vortex step followed. This procedure was repeated until the complete 250 mL volume of the μW particles solution was exhausted. Not more than one hundred (100) mL of isopropanol were used to rinse the μW particles solution flask. Step D) At this step, the flask containing 600 mL of the metal-polymer hybrid microparticle preparation step, was added with 3.81 g of PEEK pellets (millimetric sized) under vigorous vortex (2 minutes). Step E) Then, the solution was put in a rotative evaporator, tilted at 45°, and left to evaporate at 83° C. (isopropanol boiling point) in vacuum, until completely dried. This powder, referred to as “the W-containing triphased hybrid pellets” (see FIG. 5), is the feedstock for the filament extrusion. The filament resulting from the “prototype 1” preparation is expected to reach a total concentration of 10.6% volume in W in the filament.

The same procedure was repeated for the “prototype 2” method (high concentration), except for: step A) the solution of μW particles contained 121.2 g/L (30.4 g/250 mL) and that of μPEEK particles 17.4 g/L (4.36 g/250 mL), for a total expected concentration of 20.2 % volume in W in the filament. The Prototype 1 procedure was repeated for the preparation of Ag-containing triphased hybrid pellets, except for: step A) the solution of metal particles contained 21.95 g/L (5.49 g/250 mL) μAg particles, and the solution of μPEEK particles contained 5.8 g/L (1.45 g/250 mL). After Step E, this powder is referred to as “Prototype-1” Ag-containing triphased hybrid pellets”, for a total expected concentration of 10.6% volume in Ag in the filament. Finally, the Prototype 2 procedure was repeated for the preparation of Ag-containing triphased hybrid pellets, except for: step A) the solution of metal particles contained 66.09 g/L (16.52 g/250 mL) μAg particles, and the solution of μPEEK particles contained 17.4 g/L (4.36 g/250 mL). After Step E, this powder is referred to as “Prototype-2” Ag-containing triphased hybrid pellets”, for a total expected concentration of 20.2% volume in Ag in the filament.

The μW, μAg, and μPEEK particles were visualized by scanning electron microscopy (SEM; FIB-SEM, Zeiss Crossbeam 540). For the analysis, 3 μL of each solution was pipetted on a flat aluminum SEM stub (12 mm in diameter, Soquelec, C10070) coated with a carbon adhesive. The samples were coated with a thin layer of Au (5 nm). The analysis was conducted at an acceleration voltage of 5 keV, at four (4) different magnifications: —30, ×200, ×2000,and ×3600. For particle size analysis, SEM images were chosen at a magnification level for which the average-sized microparticles had a mean diameter corresponding to approximately 10% of the frame of the image. Image J (version 1.53e), specifically utilizing the freehand lines applet, was used for data analysis. Particles distributions were counted on at least 120 microparticles, except for the Ag microparticles, which were found to be too agglomerated. To account for the irregular shapes of the Wand PEEK microparticles, four (4) different diameters of each individual microparticle were measured using the freehand lines applet. This approach allowed capturing various dimensions of the particles, providing a more accurate representation of their size. The particulate size distribution graphs were then processed using Origin8 (OriginLab Corporation).

A 3Devo Next 1.0 Advanced single screw extruder from 3Devo (the Netherlands), was utilized for the extrusion process. The extruder features a vice length/diameter ratio of 15:1 and a pitch distance of 25 mm. It is equipped with four controllable ceramic heating zones (H1-H4), and it is connected to the DevoVision software Data log (DevoVision-win64-v0.2.0).

To initiate the cleaning extrusion process, the temperature setpoints of each heating element were adjusted to 300° C. (H1-H4). The Devoclean MidTemp cleaning substrate, weighing 120 g, was loaded into the hopper in fractions of 30 g. The heating elements were allowed to heat until reaching the setpoint temperature (approximately 20 min), enabling extrusion of the MidTemp material until a temperature of 300° C. (H1-H4) was achieved. Next, the temperature setpoints of the heating elements were set to 400° C. (H1-H4), and 195 g of the Devoclean HighTemp cleaning substrate was loaded into the hopper in fractions of 30 g. The heating elements were heated until each setpoint temperature was reached, approximately 45 minutes, facilitating extrusion of the HighTemp material until a temperature of 400° C. (H1-H4) was attained. This cleaning and thermal transition procedure prepared the extruder for PEEK extrusion at 400° C.

With regards to initiation of PEEK filament extrusion, after the thermal transition, the temperature setpoints of the heating elements were adjusted to optimized values for PEEK extrusion: H1: 390° C., H2: 395° C., H3: 395° C., and H4: 400° C. Subsequently, 90 g of PEEK pellets were introduced into the hopper in 30 g fractions. After 50 min of extrusion, all the HighTemp material was purged out, leaving only pure PEEK in the extrusion process. An additional 60 g of PEEK pellets was then added in two fractions of 30 g each. The extrusion process continued until a stable flow of PEEK filament was achieved, with the filament diameter set at a nominal value of 1.75±0.1 mm. The filament diameter was dynamically controlled by an optical sensor, providing feedback control to the automated winding system of the extruder.

With regards to extrusion of metal-containing PEEK filaments, the triphased preparations (“prototype-1 with μW” (157.8 g±1.2 g), prototype-2 with μW” (192.2 g±1.2 g)) were successively added as a concentrated batch in the hopper, by waiting for an almost-complete consumption of the pure PEEK pellets by the vice. A few minutes after adding the triphased preparation, a change in color appeared in the extruded filament, which indicated that the PEEK preparation was concentrated in metal particles. Then, the vice speed was reduced to 4 RPM. To accommodate the change in material viscosity, the temperature of heating zone H4 (near the nozzle) was lowered by 5° C., from 400° C. to 395° C. The filament was winded. Each preparation, extruded in triplicate, was intercalated by a batch extrusion of pure PEEK pellets (100 g of PEEK pellets added in fractions of 25 g to maintain a consistent feedstock).

Prior to the extrusion of Ag-containing PEEK filaments, the equipment was thoroughly cleaned by using 120 g of the HighTemp substrate (elimination of tungsten contamination). Then, the same extrusion procedure as described for the W-containing filaments, was repeated by using the “prototype 1 with μAg” triphased preparation (163.5 g). However, evidence of agglomeration in the μAg powder observed in the SEM analysis, translated into severe disruptions of the extruded filament. It was concluded that, without changing the μAg powder, the extrusion of a continuous, high-quality Ag-containing filament, would not be possible. At the end of the extrusion process, the extruder was purged with 200 g of Devoclean High Temp feed, followed by 200 g of Devoclean MidTemp feed.

It is noted that a variant to the extrusion process can generate W particle-enriched PEEK pellets. Indeed, introduction of W-PEEK instead of pure PEEK pellets in the triphased preparation, can allow to achieve the highest levels of metal particle concentration in the filaments. First, extrusion starters resulting from different variants 1 and 2 procedures, each containing 60 g (4.61% v./v. of W) and 160 g (9.94% v./v. of W), respectively, were collected, and cut in pieces of similar dimensions as the pure PEEK pellets (2 mm-long pieces). Then, after a step of “PEEK filament extrusion,” 60 g of PEEK-W pellets (4.61% vol) were introduced into the hopper of the extruder in 20 g batches (3×). The extrusion parameters for pure PEEK were maintained with temperatures set at H1: 390° C., H2: 395° C., H3: 395° C., and H4: 400° C., and a screw speed of 4 RPM. Then, 60 g of high-concentration PEEK-W pellets (9.94% vol) were introduced in 20 g-batches (3×). Approximately 10 minutes later, a darker, more liquid-like extrudate began emerging from the nozzle, indicating the transition to the high-concentration PEEK-W product. To accommodate the change in material viscosity, temperatures across all heaters (H1-H4) were reduced by 10° C. each. Adjustments continued until optimal temperature settings were achieved in a gradient (H1: 350° C., H2: 355° C., H3: 370° C., H4: 375° C.), effectively increasing the material's viscosity to a consistency facilitating spooling (approx. 20 min). As a last step of this procedure, triphased preparations of a medium-density tungsten mixture (14.7% v./v. W, 1.5 times the W concentration used in variant 1; 236.7 g±1.2) were added to the hopper in concentrated batches. Shortly after adding the triphased preparation, a color change was observed in the extruded filament, indicating the presence of metal particles. The screw's rotational speed was lowered to 3.5 RPM, and the filaments were spooled. Each batch of triphased preparation was alternated with a batch of pure PEEK pellets (100 g of PEEK-W pellets added in batches of 25 g) to maintain a consistent feedstock. After the extrusion process, cleaning and resetting procedures were carried out as previously described to ensure the system was prepared for subsequent runs.

In a last variant of the extrusion process, referred to as the “second pass procedure”, samples of the extrusion starters from variant 1 and variant 2 assays, were cut in small pieces and their concentration in W was estimated by the water displacement technique. A medium-density triphased PEEK-W blend was prepared, which contained an estimated concentration of 14.7 vol. %/vol. in W, which correspond approximately to 1.5 times the W concentration used for the preparation of variant 1. These small pellets were used to replace the pure PEEK pellets in the triphased blend of variants 1 and 2. Adjustments to the temperature set in each heating block in the extruder, allowed to reach the optimal viscosity. A slight reduction in the extruder vice speed, facilitated the forming of filaments having 1.75 nm in diameter. Spooling was performed at a relatively slow speed in order to avoid deforming the cooling material. In the final extruded filaments, the average W concentration at the plateau section (about 8.6 meters long), was 9.84±0.38% (referred to as PEEK-W 9% vol). The results obtained with this “second pass procedure” variant confirm the possibility to increase even further the concentration of W particles within the PEEK matrix, provided pellets already containing very well-dispersed W particles, are used in the triphased feedstock.

To demonstrate the homogeneity of microparticles distribution along the filaments, the color density gradient was thoroughly observed, and the central and homogeneous portion of each one was identified and ascribed to the “central part”. The part corresponding to the initiation of the filament, from the very first appearance of color (i.e., presence of metal-based microparticles) was identified as “initiator part”, and that corresponding to the gradient concentration fade-out, was identified as “fade-out part”.

Micro-X-ray fluorescence (micro-XRF) was used to visualize the macroscopic distribution homogeneity of W microparticles along each central concentrated part of the filaments. The analysis was conducted using a M4 Tornado spectrometer (Bruker) equipped with a Rh anode X-ray tube (50 kV, 600 μA). Each filament (length: 2.5 m; 1.75±0.05 mm in diameter) was placed as spirals in the microXRF, lying flat on the horizontal surface of the system. Prior to X-ray irradiation, photographs were taken of each spiralled filament, as a visual positioning reference to each analysis. Then, elemental maps were taken on the whole filament, covering 15 cm² areas at a time, with a step size of 20 μm and an acquisition time of 5 ms per step. Finally, a point mode analysis was performed every 20 cm along the filament, by selecting rectangular regions of interest centered inside about ⅓ of the diameter of the filament. This approach aimed at guaranteeing that only the highest intensity of the W characteristic X-rays, corresponding to the thickest part along each filament, was measured. A spot size of 200 μm and an acquisition time of 100 seconds were kept throughout the analysis. The counts were integrated over an energy window centered around the Lα peak (8.39 keV) of interest, and the resulting values were expressed in counts per second (cps).

Tungsten concentration in the filaments was determined on a selection of 2-cm samples extracted (~10 mg each) at regular spacing along the gradient parts of the extruded filaments. After micro-XRF measurement, each sample was precisely weighted (about 10 mg each sample), and digested in Teflon tubes with 6 mL sulfuric acid (H₂SO₄ trace metal grade), 6 mL hydrochloric acid (HCl trace metal grade), 3 mL nitric acid (HNO₃ trace metal grade), and 3 ml of hydrofluoric acid (HF diluted at 40%, trace metal grade), under microwave-assisted acid digestion (MW-AD; 20 min heating ramp until 220° C. (ramp), then held 40 min same temperature; MultiVIEW Microwave System, SCP Science). After digestion, the resulting solutions were separately diluted by adding 15 ml of solvent to each tube, resulting in a final volume of 25 ml for each sample. These diluted solutions were then analyzed by Microwave Plasma Atomic Emission Spectrometry (MP-AES; Analyst 800 from PerkinElmer; MP-AES 4210) Agilent system. As controls, triplicate samples of hybrid PEEK-metal microparticles with a known concentration of 50 wt % tungsten (W) was prepared. A triplicate mixture of metallic microparticles and PEEK polymer (W contents: 16 % vol./73 % wt. and Ag contents: 19 % vol./65 % wt.) were digested using the same protocol and used as reference. This involved mixing 200 g of PEEK and 200 g of dried tungsten microparticles to create three separate mixtures of powders. Sections from the extruded filaments were sampled at regular intervals in the “plateau” section, the part of the filament with the highest concentration in metal microparticles). The sections were cut, then prepared and visualized by SEM.

Computer-aided design (CAD) drawings of samples (20 mm×8 mm) featuring 0.2-mm steps (2 mm wide) were prepared (software CREO Parametric Student edition, Version: 6.0, Boston, USA) (FIG. 10A). Each one of the CAD models were converted into .stl files (CREO software) using the finest meshing parameters. The 3D models (.stl) were then imported in a slicer software (Simplyfy 3D, Version: 4.1.2, Simplify 3D inc.; Ohio, USA) to generate a gcode file. Each one of the print batches included 3 replicates. Brims, or excess layers of printed material extending at critical contours of the object were added to the procedure to enhance the contact between the impression bed and the printed object. The coupons were printed with a PEEK FFF printer (P220, Apium Additive technologies GmbH, Karlsruhe, Germany). A 0.4-mm diameter printing nozzle was used, thoroughly cleaned using a wire brush before each experiment. The printing was performed at a 0.1-mm layer thickness, with nozzle and printed temperatures of 485° C. and 130° C., respectively. Throughout the printing process, the filament was kept at a temperature of 60° C. The coupons were printed in three (3) different materials: low-concentration μW-PEEK (“prototype 1”), high-concentration μW-PEEK (“prototype 2”), and pure PEEK. Before printing, a fixative (DimaFix, DIMA 3D, Valladolid, Spain) was applied on the printed to ensure first layer adhesion during the process. Prior to printing, the PEEK filaments were dried at 80° C. for 3 hours using a dedicated tool (FD1, Apium Additive technologies GmbH, Karlsruhe, Germany). Each CAD model was printed at least in triplicate, and the dimensions were verified using a digital caliper (15 cm long, +0.005 cm, Mastercraft, Canada) after post-processing.

X-ray computed tomography (CT) was used to assess the attenuation of X-rays by the 3D-printed materials. The measurements were performed using a μCT scanner (GE explore Locus) operating at 80 kV tube voltage and 450 mA tube current. The imaging and reconstruction were performed with a voxel size of 89 μm. ImageJ software was utilized for CT image analysis.

In order to obtain high quality X-ray images, detector binning=2×2, voxel resolution=45 μm, and 3 frames averaging setting were used. The images were reconstructed using Parallax Innovations Reconstruction tool (Parallax Innovations, Ilderton, ON, Canada). The EP contours on the reconstructed images were delineated and visualized by manual adjustment of greyscale threshold values, using the Isosurface tool in MicroView (Parallax Innovations version: 2.5.0, Ilderton, ON, Canada). Image segmentation was performed by setting a surface quality factor to 100 % (maximum) and surface smoothing option enabled. These segmented images were saved in .stl format and used for comparative analysis to evaluate the geometrical accuracy of the 3D-printed Eps.

In this example, polyetheretherketone (PEEK) was used as a chemically resistant polymer with excellent thermal and mechanical properties. It is increasingly used for the development of 3D printed orthopedic implants, as well as in radiotherapeutic applications requiring the insertion of permanent and non-permanent implants in the body. Although PEEK is resistant to radiolysis-polymer degradation by ionizing radiation-it is a radiolucent material that expresses a poor capacity to block radiation (energetic photons, neutrons). Many personalized devices and tools in radiology, radiotherapy and in nuclear medicine, such as brachytherapy implants, shields, screens, and personalized radioprotection equipment, require a certain level of radiopacity in their components. This works describes a novel procedure that allows the development of radiopaque PEEK filaments for fused filament fabrication (FFF) 3D printing. Such filaments contain a homogeneous distribution of electron-dense particles (micro or nanoparticles) that confer a high radiation blocking power to the printed objects. First, an original methodology was developed for an optimal pre-mixing of micrometric-sized metal particles (here: tungsten) with micrometric-sized PEEK particles, prior to their addition to millimetric-sized PEEK pellets. Thus-prepared mixture of three types of (3) particles allowed an efficient extrusion of the materials in the form of a continuous and robust filament that can be inserted in a commercial FFF PEEK printer. The filaments were characterized in electron microscopy and X-ray fluorescence imaging for particle distribution homogeneity and in elemental analysis for the total contents in radiation-blocking material. The filaments having reached a >5% v/v blocking materials contents were characterized with DSC for their fusion temperature, then used in a commercial PEEK 3D-printed for the fabrication of radiopaque phantoms of various thicknesses. The 3D printing resolution and the X-ray attenuation coefficients were evaluated and measured by X-ray radiography and computed tomography (CT). This work opens the possibility to 3D print radiopaque polymer parts made of mechanically and chemically resistant material with several applications in medicine, airspace, and the nuclear industries.

As can be understood, the examples described above and illustrated are intended to be exemplary only. Although the radiopaque paste or filament was described above in the context of the medical industry (e.g., in radiological applications, radiotherapeutic applications), the radiopaque paste or filament described herein can be used in any other application which requires radiopacity including, but not limited to, the aeronauticondustry, the aerospace industry, the nuclear industry, the electronic and electrical industries, and the like. The scope is indicated by the appended claims.

1. A method of producing a radiopaque object, the method comprising:
mixing a plurality of metallic particles and a plurality of polymer particles into a liquid medium, said mixing including the plurality of metallic particles assembling around respective ones of the plurality of polymer particles and resulting in a plurality of first colloidal structures suspended in the liquid medium;
incorporating a plurality of polymer pellets into the liquid medium, the polymer pellets having a first dimension greater than a second dimension of the polymer particles, said incorporating including the plurality of first colloidal structures assembling around respective ones of the plurality of polymer pellets and resulting in a plurality of second colloidal structures suspended in the liquid medium;
separating the plurality of second colloidal structures from the liquid medium; and
forming the plurality of second colloidal structures into the object.

2. The method of claim 1 wherein the polymer particles are made of a first extrudable polymer material, the polymer pellets made of a second extrudable polymer material, said forming including extruding the plurality of second colloidal structures into a filamentary object.

3. The method of claim 2 wherein the first extrudable polymer material and the second extrudable polymer material correspond to a same, given extrudable polymer material.

4. The method of claim 3 wherein the given extrudable polymer material is selected from a group consisting of: polyether ether ketone (PEEK), nylon (polyamide), acrylonitrile butadiene styrene (ABS), polylactide (PLA), polycarbonate (PC), polyethylene terephthalate glycol (PETG), polycaprolactone (PCL), polypropylene (PP), polymethyl methacrylate (PMMA), polystyrene (PS), polyetherketoneketone (PEKK), polyethylenimine (PEI) and polyethylene (PE).

5. The method of claim 1 wherein the metallic particles includes a metallic material includes high-Z elements found in the solid form at room temperature and normal conditions.

6. The method of claim 1 wherein the first dimension of the polymer pellets range between 100 microns to 20 mm.

7. The method of claim 1 wherein the second dimension of the polymer particles range between about 100 nm to about 100 microns.

8. The method claim 1 wherein the metallic particles have a third dimension ranging between about 100 nm to about 100 microns.

9. The method of claim 1 wherein the metallic particles and the polymer particles have at least one of: substantially similar dimensions, substantially similar volumes and substantially similar quantities.

10. The method of claim 1 wherein the second colloidal structures have a metallic composition of at least 5 %, preferably at least 10 % and most preferably at least 20 %.

11. The method of claim 1 wherein said separating includes drying a mixture having the liquid medium and the second colloidal structures from the liquid medium.

12. The method of claim 1 wherein the liquid medium includes an alcohol selected from a group consisting of: isopropanol, ethanol, and methanol.

13. The method of claim 1 wherein said mixing includes providing the plurality of metallic particles in the form of a first colloidal suspension, providing the plurality of polymer particles in the form of a second colloidal suspension, and mixing the first colloidal suspension and the second colloidal suspension to one another.

14. The method of claim 13 wherein said mixing the first colloidal suspension and the second colloidal suspension to one another includes gradually mixing the first colloidal suspension into the second colloidal suspension.

15. The method of claim 1 further comprising subjecting the liquid medium to at least one of an agitation step and a sonication step.

16. A radiopaque structure comprising: a polymer pellet having a first dimension between 100 microns to 20 mm, and a plurality of auxiliary colloidal structures assembled around the polymer pellet, the auxiliary colloidal structures having a polymer particle, the polymer particle having a second dimension ranging between about 100 nm to about 100 microns, and a plurality of metallic particles assembled around the polymer particle, the metallic particles having a third dimension ranging between about 100 nm to about 100 microns.

17. A method of producing a radiopaque feed material, the method comprising: mixing a plurality of metallic particles and a plurality of polymer particles into a liquid medium, said mixing including the plurality of metallic particles assembling around respective ones of the plurality of polymer particles and resulting in a plurality of first colloidal structures suspended in the liquid medium; incorporating a plurality of polymer pellets into the liquid medium, the polymer pellets having a first dimension greater than a second dimension of the polymer particles, said incorporating including the plurality of first colloidal structures assembling around respective ones of the plurality of polymer pellets and resulting in a plurality of second colloidal structures, the plurality of colloidal structures forming the radiopaque feed material.

18. The method of claim 17 wherein the first dimension of the polymer pellets range between 100 microns to 20 mm, the second dimension of the polymer particles ranging between about 100 nm to about 100 microns.

19. The method of claim 17 wherein the metallic particles have a third dimension ranging between about 100 nm to about 100 microns.

20. (canceled)
